(19) United States
(12) Patent Application Publication
(10) Pub. No.: US 2007/0276688 A1
(43) Pub. Date: Nov. 29, 2007

(54) Interactive Resource Competition and Competitive Information Display

(75) Inventors: Tongyu Sun, Hangzhou (CN); Yulei Wang, Hangzhou (CN); Dong Chai, Hangzhou (CN); Peng Jiang, Hangzhou (CN); Anning Li, Hangzhou (CN); Jianfeng Zhang, Hangzhou (CN); Lijuan Chen, Hangzhou (CN)

Correspondence Address: LEE & HAYES, PLLC, 421 W. RIVERSIDE AVE, STE 500, SPOKANE, WA, 99201, US

(73) Assignee: ALIBABA.COM CORPORATION, Grand Cayman (KY)

(21) Appl. No.: 11/746,005

(22) Filed: May 8, 2007

(30) Foreign Application Priority Data
May 10, 2006 (CN) 200610079679.3

(51) Int. Cl. G06Q 10/00; G06Q 30/00

(52) U.S. Cl. 705/1

(57) ABSTRACT

Interactive resource competition ranks resource users using coefficients of performance (CoP). Resource users compete for a target resource and each offer a quantifiable reciprocal resource in exchange for using the target resource. A trigger frequency of a predetermined action with respect to the target resource is recorded, and the CoP based on the respective reciprocal resource value and the trigger frequency is determined. The target resource is then allocated based on the ranking of the CoP's. An intermediate and credit fund account is used for both making payments and recording the trigger frequency. The competition is particularly useful for allocating an information display position in online electronic marketing.

### RELATED APPLICATIONS

This application claims benefit of an earlier filing date of Chinese patent application, Application No. 200610079679.3, filed May 10, 2006, entitled “SYSTEMS AND METHODS FOR INTERACTIVE RESOURCE COMPETITION AND COMPETITIVE INFORMATION DISPLAY”.

### BACKGROUND

This application relates generally to data processing in network resource management, and particularly to interactive resource competition, such as competitive information display involving multiple information objects competing for an information display position, and price-bid ranking of product information used in online marketing.

In an existing network system, a resource management system usually has a certain resource (e.g., as data transmission bandwidth, data transmission priority and data transmission Quality of Service (QoS)), or certain data or information that is valuable to a resource user. In a noncompetitive situation, the resource management system may freely allocate one or more resources to a certain resource user (e.g., an end-user or data port) according to the requests sent by the resource user. However, often two or more resource users simultaneously request the same resource which cannot be divided or shared. Under such circumstances, it has remained a challenge to intelligently allocate the best suitable resource to the most appropriate data user. In many respects, network resource allocation in a competitive environment has so far remained an unsolved problem. The problem is especially evident in applications where resource users use the resource to trigger a specific operation or action by a third party. In such applications, optimizing the resource allocation poses a particularly great technical challenge because the existing technology's inability to record or acquire the knowledge of third-party-specific actions.

For example, in the field of information display, multiple information objects may request for a certain target information display position to display an information object. The information object displayed often contains product information to trigger a purchase action by a buyer who is usually a third party in relation to the seller and the information display service provider. The existing resource management systems are inadequate for optimizing the allocation of the target information display position among the competing information objects that are used to trigger a specific operation by a third party.

Typically, the existing technology uses keywords to group the competing information objects and reject those information objects that do not contain a relevant keyword. Among the information objects that have equal relevance to the same keyword(s), the resource allocation is usually done in a random manner or a manner with little intelligence. Alternatively, the existing technology categorizes the competing information objects under certain subject categories and decides which category of the competing information objects are the most relevant and therefore deserve a display position. Again, within a relevant category, the resource allocation is done randomly.

In general, the conventional technology is unable to further optimize the resource allocation beyond keywords or categories because the system has no third-party user specific information, especially performance related information, as a basis for intelligent optimization.

### SUMMARY

Techniques for interactive resource competition are described. The techniques enable optimized allocation of a resource among competing resource users. The techniques aim to minimize resource waste by conferring a favorably suitable resource to an advantageous resource user. The techniques are adapted for acquiring user-specific information related to performance, efficiency and benefit, and for using the acquired user-specific information to ascertain a coefficient of performance (CoP) for each resource user. A variety of ways to use the CoP of resource users to achieve intelligent optimization of resource allocation are disclosed.

One aspect of the techniques is a method for interactive resource competition among a plurality of resource users competing for a target resource. In some embodiments, the method presets a target resource, and receives a reciprocal resource or an offer of a reciprocal resource from each resource user in exchange for using the target resource. The reciprocal resource is preferably quantifiable and can be represented by a reciprocal resource value. The method then records a trigger frequency of a predetermined action figure during a predetermined period of time by each resource user using the target resource, and determines the CoP of each resource user based on the respective reciprocal resource value and the trigger frequency. Finally, the method allocates the target resource based on the determined coefficients of performance.

In one embodiment, the CoP has a positive correlation with the reciprocal resource value and the trigger frequency. For example, the CoP may be proportional to both the reciprocal resource value and the trigger frequency. The CoP of each resource user may be calculated by simply multiplying the reciprocal resource value by the trigger frequency of the respective resource user. In a more sophisticated model, the CoP of each resource user may be obtained by: (1) multiplying the reciprocal resource value by a resource modifying factor to obtain a modified reciprocal resource value; (2) multiplying the trigger frequency by a trigger frequency modifying factor to obtain a modified trigger frequency; and (3) multiplying the modified reciprocal resource value by the modified trigger frequency to obtain the CoP of the respective resource user.

In a straightforward application, the target resource may be conferred to the resource user having the greatest coefficient of performance. If the resource users all have the same CoP, or have similar CoP's that are too close to each other to be meaningfully ranked apart, the target resource may be conferred to the resource user having the highest trigger frequency. It is appreciated that whether two or more CoP's are too close to each other to be meaningfully ranked apart is a subjective business decision rather than a precise mathematical determination.

The method can be implemented in various types of applications. For example, the target resource may be data transmission bandwidth, data transmission priority, data transmission Quality of Service (QoS) or information display position. The same principles of the method can be used to achieve optimized allocation of any of these exemplary target resources.

The reciprocal resource offered by resource users may also take various forms. One typical example of a reciprocal resource is an offer price for using the target resource.

The predetermined action triggered by each resource user using the target resource varies according to the purpose of the resource user. One typical example of a predetermined action triggered using the target resource is completion of an electronic commerce transaction.

In one embodiment, the method uses an intermediate credit fund account to make payments involved in an electronic commerce transaction triggered by each resource user using the target resource. Making payments is a common and critical component in completion of an electronic commerce transaction. The trigger frequency of electronic commerce transactions may be recorded by counting the number of successful payments made to or through the intermediate credit fund account in relation to the electronic commerce transactions triggered by each resource user. Furthermore, in the case where the reciprocal resource of each resource user is an offer price, the method may further charge the offer price using the intermediate credit fund account upon the completion of the triggered electronic commerce transaction.

Another aspect of the present disclosure is a method for allocating an information display resource among a plurality of competing information objects, each of which may include product information used in electronic commerce. In some embodiments, the method presets an information display position and receives for each information object a bidding price in exchange for the information display position. The method records a completion frequency of electronic commerce transactions triggered by each information object during a predetermined period of time. The method then determines a coefficient of performance of each information object based on the respective bidding price and the number of completions triggered. In one embodiment, the coefficient of performance has a positive correlation with the bidding price and the completion frequency.

In a straightforward application, the target information display position is conferred to the information object having the greatest CoP. If the information objects all have the same CoP, the information display position may be conferred to the information object having the highest completion frequency.

Another aspect of the disclosure is a price-bid ranking method for ranking a plurality of product information objects used in online marketing. In some embodiments, the method receives for each product information object a bidding price for ranking, and receives a search query from a user. The method then finds product information objects that satisfies the search query and ranks the matching product information objects according to the coefficients of performance (CoP) thereof. The CoP of each information object is a function of the bidding price and completion frequency of object transactions triggered by the product information object. A typical object transaction is a sale of a product described in a product information object. Information display position(s) may be then allocated among the matching product information objects according to the ranking of the matching product information objects.

Yet another aspect of the present disclosure is a system for competitive display of a plurality of information objects, each of which including product information for electronic commerce.

The present application discloses a management unit to record predetermined third-party actions triggered by a target resource used by a resource user. The recorded information provides knowledge related to the performance of each competing resource user using the target resource, making possible a more intelligent resource allocation scheme. By allocating the target resource to the best-performing resource users, the present invention is useful for avoiding resource waste and able to use the target resource more advantageously.

Other features and advantages of the disclosure will become more readily understandable from the following detailed description and figures.

### BRIEF DESCRIPTION OF THE FIGURES

The detailed description is described with reference to the accompanying figures. In the figures, the left-most digit(s) of a reference number identifies the figure in which the reference number first appears. The use of the same reference numbers in different figures indicates similar or identical items.

FIG. 1 is a flow diagram of an exemplary process for interactive resource competition among multiple resource users competing for a target resource.

FIG. 2 is a flow diagram of an exemplary process of competitive information display.

FIG. 3 is a diagrammatic illustration of an exemplary system for competitive display of information objects.

FIG. 4 shows a flow diagram of a price-bid ranking process.

### DETAILED DESCRIPTION

In this description, the following terms are used in their broadest meaning and should be interpreted accordingly as explained below.

A resource user may be an individual person, a group of people, a computer program, a data terminal, or a data port, that participates in information exchange in resource allocation.

A target resource may be any useful computer resource or computational system resource, such as data transmission bandwidth, data transmission priority, data transmission Quality of Service (QoS), or an information display position. The target resource may be used for any purpose intended by a resource user, either directly or indirectly. The target resource may be used by the resource user to trigger or activate a certain action or behavior of a third-party, but may also be solely used by the resource user without triggering another party's action.

An electronic commercial transaction may be any electronic transaction involving a commercial activity such as selling, buying, trading, exchanging, bidding, auctioning, and making or receiving a payment.

An information display position includes, but not limited to, any one of the following or a combination thereof: a single ranking entry, a ranked list of multiple entries, a single display position for a link, and a ranked list of multiple links.

An information object includes, but not limited to, any of the following or a combination thereof: a text, an image, a sound, an animation, a video, and a movie. A product information object content is information of a certain product, goods or service, and may include an active Internet link to the checkout process where a purchase is completed with making a payment, but may also include a link to more product information and more product selections.

An offer price is a value offered by a resource user for using a target resource.

A bidding price is a special type of offer price offered in a price-bid competitive resource allocation, for example a bid for an information object to occupy a predetermined information display position.

A trigger frequency is the number of actions triggered by the information object during a predetermined period of time.

A completion frequency is a special type of trigger frequency defined by the number of completed electronic commercial transactions triggered by the information object during a predetermined period of time.

The processes below are each illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

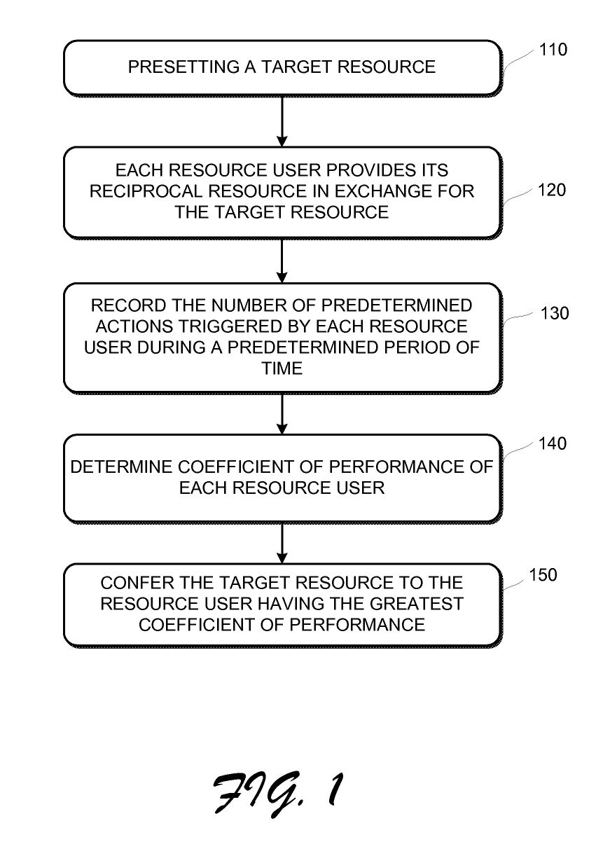

FIG. 1 shows a flow diagram of an exemplary process for interactive resource competition among multiple resource users competing for a target resource. Two or more resource users may compete for the target resource. Competition occurs when the usages of the target resource requested by two or more resource users overlap with each other and cannot be all satisfied at the same time, or otherwise contradict with each other. The illustrated process in FIG. 1 applies to any target resource suitable for competitive allocation, including data transmission bandwidth, data transmission priority, data transmission QoS, and an information display position. For example, the method can be used in online marketing in which there predetermined action triggered by each resource user comprises completion of an electronic commerce transaction. The process shown in FIG. 1 is described in blocks in the following.

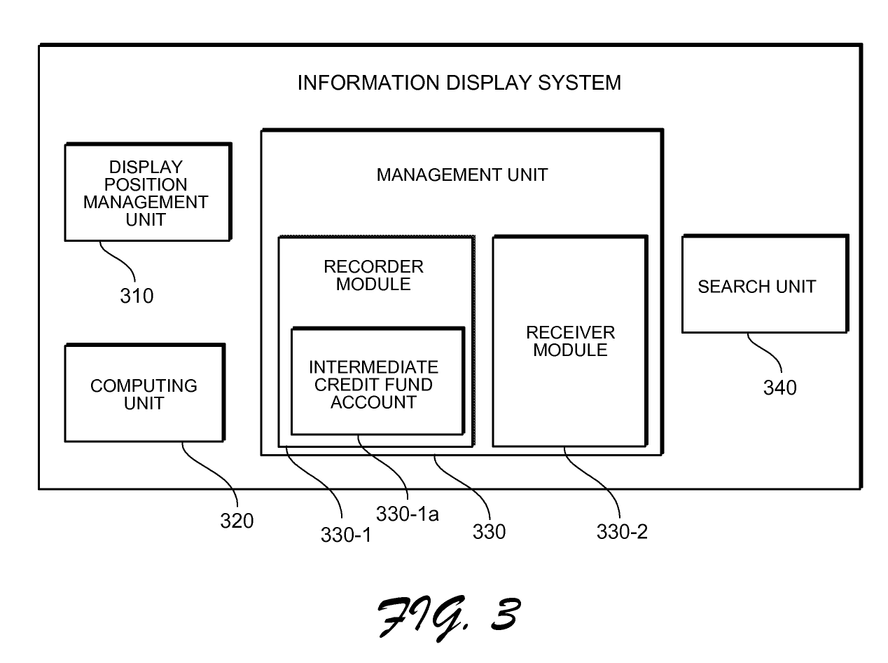

At block 110, a management unit presets a target resource to be available for competitive allocation among multiple competing resource users. The management unit typically includes a computer or a computer system. As will be further described in detail with reference to FIG. 3, the management unit may also include a recorder module and a receiver module to perform other functions as described below.

At block 120, the management unit receives from each resource user a reciprocal resource (or an offer of a reciprocal resource) in exchange for using the target resource. The reciprocal resource can be any suitable resource that can be accepted as a token of value offered by a resource user in exchange for use of the target resource. The reciprocal resource is preferably quantifiable, or at least contains a part that is quantifiable, and can be represented by a reciprocal resource value. A simple example of a reciprocal resource is an offer price or an offer of a payment of a monetary fund, such as cash or credit.

At this block, as long as information of a quantifiable value of the reciprocal resource is received, the reciprocal resource itself is not required to be delivered in real time or in any immediate manner. For example, the management unit may receive only an offer of a reciprocal resource which is to be delivered later. This delayed deliverance model is typical in electronic commercial transactions in which a purchase or an offer for payment is first made, while the actual payment is to be made sometime later using a credit card, a credit account, or any other suitable payment methods.

At block 130, the management unit records the number of predetermined actions triggered by each resource user during a predetermined period of time. The predetermined period of time can be any length suitable for the purpose of the method. It can be a day, a week, or a month, etc., and can be set by the management unit according to implementation specifications or administrator preferences.

In general, a resource user acquires the target resource for a certain application which may involve a certain action or behavior of the resource user and/or that of a third-party user. For example, an online seller may acquire from a search engine provider a certain information display position in the listing of search results to display its product advertisements carrying product information. In this case, the online seller uses the target source (information display position in the listing of search results) to trigger a certain third-party action (such as a mouse click on an Internet link) which leads to a purchase of the product. The management unit may record the number of clicks triggered or the number of purchases actually made, or both. As will be illustrated in other examples herein, one way to record the number of purchases actually made is to record the successful payments that have been made through an intermediate financial account.

The number of predetermined actions successfully triggered by each resource user during a predetermined period of time gives a trigger frequency of the resource user using the target resource. As shown below, the knowledge of the trigger frequency is used, in part, for evaluating the performance of the resource user.

At block 140, the management unit determines a coefficient of performance (CoP) of each resource user based on the respective reciprocal resource value and the trigger frequency. The CoP of the resource users will be used as a basis for allocating the target resource. The CoP can be seen as a function of the reciprocal resource value and the trigger. The exact function can vary according to the design goal and actual needs. But normally, the CoP should desirably have a positive correlation with the reciprocal resource value and the trigger frequency to properly represent the performance of the resource user. That is, a higher reciprocal resource value and a higher trigger frequency should result in a greater CoP to reflect a better performing or a more advantageous resource user.

One way to define and calculate the CoP is to simply multiply the reciprocal resource value by the trigger frequency of the respective resource user. Modifying factors may be introduced to modify this simple definition of the CoP. For example, the CoP of a resource user may be calculated by multiplying a modified reciprocal resource value by a modified trigger frequency of the same resource user, where the modified reciprocal resource is obtained by multiplying the reciprocal resource value by a resource modifying factor, and the modified trigger frequency is obtained by multiplying the trigger frequency by a trigger frequency modifying factor. Many other formulas may be used to define and calculate CoP to suit the purpose of a specific application. Such formulations are within the reach of those skilled in the art and will not be discussed here for the sake of conciseness.

At block 150, the management unit allocates the target resource based on the CoP's of the resource users. The values of the CoP's of the multiple resource users provide knowledge about the performance and benefits of each resource user to allow intelligent optimization of target resource allocation. Various schemes may be designed to take advantage of this knowledge. In general, it is more advantageous to confer the target resource to the resource user(s) that have the best performance in a beneficial way. Because the CoP is a measurement of the performance (both in terms of benefits and efficiency) of a resource user, conferring the target resource to the resource user having the greatest CoP is a natural, although not mandatory, choice. In case where multiple resource users have the same CoP, the target resource may be given to the resource user having the highest trigger frequency; alternatively, the target resource may be given to the resource user having the highest reciprocal resource value.

After block 150, the process may repeat from any of block 110, block 120, block 130 and block 140. For example, if a different target resource is to be allocated, or a change occurred to the present target resource that would require resetting, the process may repeat from block 110; if the target resource remains the same but the bidding has changed, the process may repeat from block 120; or if both the target resource and the bidding remain the same, the process may repeat from block 130.

In some embodiments, block 130 may be an ongoing continuous process happening in real time as the predetermined actions are triggered, while block 140 is performed periodically at preset time intervals. In some embodiments, block 140 may also be a continuous process performed in real time whenever the output of block 130 provides a new result.

Because in some applications the predetermined action involves a third-party action, recording the trigger frequency may require some deliberate arrangement. One way to enable the management unit to record the trigger frequency of third-party actions is to use an intermediate credit fund account and require the involved parties to use the intermediate credit fund account to complete the triggered actions. For example, in electronic commerce applications where the triggered action is a purchase of a product by a third-party buyer, buyers may be required to make payment through an intermediate credit fund account. With this arrangement, the management unit may count the number of successful payments made to or through the intermediate credit fund account in relation to the electronic commerce transactions triggered by each resource user. The number of successful payments at least partially represents the number of purchases triggered by the resource user.

In case where all buyers use the intermediate credit fund account, the number of successful payments would be the same as the number of successful purchases with a completed payment. In fact, the number of successful payments may be very close to the number of all purchases triggered by the resource user, as only those triggered purchases that have failed to make a payment, either because of abandonment or cancellation by the buyer, or an interruption by technical problems, will not be counted in the number of successful payments. Because such unsuccessful purchases are random events and are likely to have an equal probability to affect all resource users, missing them in the counting is unlikely to affect the accuracy of the CoP in its measuring the relative performance of a resource user. In particular, because the CoP is used for optimizing resource allocation, it would be considered accurate as long as it is truthful in reflecting relative performances of the resource users.

Even in applications where not all buyers use the intermediate credit fund account, the number of successful payments made through the intermediate credit fund account may still be proportional to the total number of purchases triggered by the resource user, and thus can be used for estimating or calculating the CoP. This is especially true if buyers triggered by different resource users have the same or similar probability to use the intermediate credit fund account. If there is evidence that buyers triggered by different resource users have different probabilities to use the intermediate credit fund account, and there is further knowledge (such as statistical data) of such different probabilities, the CoP's of different resource users may be calculated using different modifying factors that reflect the different probabilities. In this case, the CoP's calculated using modifying factors may be more accurate in measuring the actual performance of each resource user.

The reciprocal resource offered by each resource user in exchange for the target resource may be an offer price or an offer for payment of a monetary fund, as commonly found in online commerce transactions. In these applications, the intermediate credit fund account may also be used for charging the offer price on the respective resource user. The offer price may be charged through the intermediate credit fund account upon the completion of each triggered electronic commerce transaction. In practice, the payment process may be carried out as follows: (1) the buyer makes payment by depositing or transferring fund of the purchase value (usually the sold price of the product) into the intermediate credit fund account; and (2) the intermediate credit fund account transfers a net value of the purchase to a receiving account held by the resource user (e.g., the seller) by deducting the offer price for using the target resource from the purchase value.

The management unit may also set certain interactive conditions to further regulate or modify the competitive allocation of the target resource. For example, as a certain interactive condition is set, the management unit may reject a resource request by a resource user who does not satisfy the set condition. This may improve the processing efficiency. Examples of such interactive conditions include (1) whether the resource user has already been given another target resource which may be exclusive of, or otherwise biased against, the present target resource; (2) whether the resource user satisfies a keyword condition; and whether the particular resource user (e.g., a data port) is recognized by the management unit.

The method in accordance with the present invention may be applied in various applications involving different target resources and different triggered actions. One particularly suitable application is in competitive information display, as illustrated below in detail.

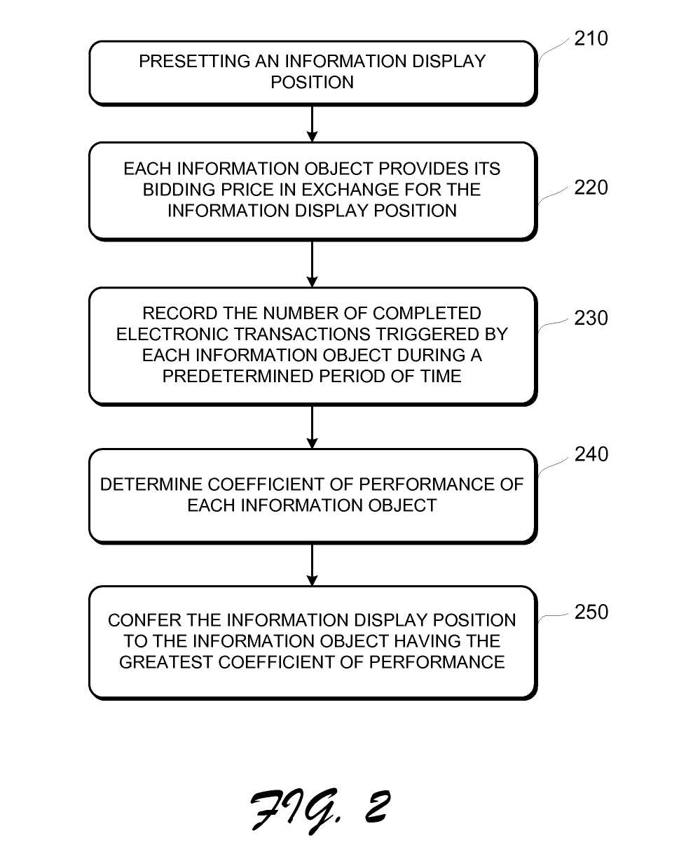

FIG. 2 shows a flow diagram of an exemplary process of competitive information display in accordance with the present invention. Two or more information objects compete for an information display position. Each information object may include product information used in electronic commerce. Each information display position may be used for displaying one or more information objects. But for simplicity each information display position is preferably for displaying a single information object only, and a plurality of information display positions are used for displaying a plurality of information objects.

The process shown in FIG. 2 is applicable to a variety of information display applications including computer screen displays, particularly commercial information displayed as a part of Internet search results, and non-computer type displays such as billboards. Internet search results may be an advertisement section of the search listings of a general purpose search engine, or a part of a dedicated online shopping webpage. The process is described in blocks below.

At block 210, the management unit presets an information display position. The information display position does not have to be a static position, but should preferably be a well-defined and identifiable position for each rendering of the information display. Multiple information objects compete for the information display position. For example, on a display page of computer search results, multiple information objects each having product information may be competing for a particular ranking position in the search results, or a particular placement position in a sidebar display containing sponsored links or promotion links.

At block 220, the management unit receives from each resource user (e.g., a seller, or an advertiser) a bidding price in exchange for displaying an information object at the preset information display position. Typically, each information object may be designed and prepared by the respective resource user according to a certain format requirement set by the management unit.

At block 230, the management unit records a completion frequency of electronic commercial transactions triggered by each information object during a predetermined period of time. The type of electronic commerce transactions depends on the nature of the information object and the product described in the information object. Most commonly, the electronic commerce transaction is a sale of the product described in the respective information object.

At block 240, the management unit determines the coefficient of performance (CoP) of each information object based on the respective bidding price and the completion frequency triggered. In a common application, the CoP of each information object has a positive correlation with the respective bidding price and the completion frequency.

At block 250, the management unit allocates the information display position based on the determined CoP's. In a typical application, the information display position is conferred to the information object having the greatest CoP. If multiple information objects have the same CoP, the information display position may be conferred to the information object having the highest offer price. Alternatively, the information display position may be conferred to the information object having the highest completion frequency.

Similar to the process illustrated in FIG. 1, after block 250 the process may repeat from any of block 210, block 220, block 230 and block 240, depending on the situation and needs.

The CoP of each information object may be calculated by multiplying the bidding price by the completion frequency of the respective information object. With a modified CoP definition, CoP may be calculated by multiplying a modified bidding price by a modified completion frequency, where the modified bidding price is the product of multiplying the bidding price by a bidding price modifying factor, and the modified completion frequency is the product of multiplying the completion frequency by a completion frequency modifying factor.

According to one embodiment of the method, an intermediate credit fund account is used for making payments of the electronic commerce transactions for each information object. The intermediate credit fund account provides a means to count the number of successful payments made, which number is used for determining or estimate the number of completed electronic commercial transactions triggered by the information object, which latter number is in turn used for determining the CoP of the information object.

An exemplary process to implement an intermediate credit fund account is described as follows:

(1) A third-party user (e.g., a buyer) conducts a search or browses for a product to purchase at certain display equipment (such as a computer screen). The third-party user finds the product described in a certain information object displayed at a visible information display position. The information display position was conferred to a resource user (e.g., a seller or advertiser) to display the information object containing the product information.

(2) Triggered by the information object, the third-party user starts an electronic commercial transaction. Typically, the third-party user starts the electronic commercial transaction for the purpose of purchasing the product.

(3) The third-party user makes a payment to or through the intermediate credit fund account.

(4) The management unit notifies the seller of the sale and payment.

(5) The seller delivers the appropriate product the buyer intended to buy.

(6) After confirming that the electronic commercial transaction is now complete (e.g., upon receiving verification from the buyer), the management unit transfer funds of an appropriate amount to the seller. The transferred amount may be a net amount corresponding to the sold price deducted of the offer price of the seller for using the information display position. Alternatively, the transfer of the sold price and the deduction of the offer price may be conducted separately as two operations.

Furthermore, the process may also incorporate keywords, phrases and/or categories that match a search query to increase the efficiency. For example, the management unit may set a keyword that matches a search word entered by the buyer, and reject the information objects whose product information does not contain the keyword. The target resource is then allocated among the information objects whose product information does contain the keyword. Similarly, category information may be used divide the information objects into different categories. The target resource is allocated within a matching category that meets a particular condition, such as a search word or a category selection by a third-party buyer. It is noted that in this disclosure, a search query is defined in its broadest form and is not limited to an entry of a keyword or a phrase. For example, a user selection (e.g., by clicking on a link) of a product category is considered a search query. In general, a search query may be performed in any suitable form and may contain any type of information related to a product.

The above process illustrated in FIG. 2 may be repeated to allocate other information display positions. If an information object that has already taken one of the information display positions is not permitted to take another information display position at the same time, the winning information object in the first iteration of the process should be excluded in the second iteration of the process, and so on, until all information display positions preset by the management unit have been allocated.

Block 220, block 230 and block 240 may be repeated to determine the CoP's of all competing information objects, which are then ranked according to their respective CoP. Available information display positions are also ranked, according to, for example, desirability, and then allocated to the information objects according to the ranks. The allocation may usually be a straightforward rank-by-rank scheme in which the information object with the highest CoP receives the most desirable display position, and so on, but may also take exceptions and modifications.

One or more information display positions may be reallocated when the offer prices and competition frequencies of information objects have changed. Reallocation may also be performed in the event of system reconfiguration, new policy implementation, and user demands and requirements.

FIG. 3 shows an exemplary system for competitive display of information objects in accordance with the present invention. The system can be used for executing the process of competitive display of information objects illustrated in FIG. 2, where a plurality of information objects compete for an information display position.

As shown in FIG. 3, the information display system has a display position managing unit 310, a computing unit 320, a management unit 330, and a search unit 340.

The display position managing unit 310 predetermines an information display position and confers the information display position to an information object according to the coefficient of performance (CoP) of the information object. For example, the display position managing unit 310 may rank the information objects according to their CoP and confer the information display position to the information objects based on the CoP ranking result.

The computing unit 320 is for calculating the CoP as a function of a bidding price and a completion frequency, which is the number of completed electronic commercial transactions triggered by the information object during a predetermined period of time. In a common application, the CoP has a positive correlation with the bidding price and the completion frequency.

The management unit 330 includes subunits recorder module 330-1 and receiver module 330-2. The receiver module 330-1 is used for receiving the bidding price, and the recorder module 330-2 is used for recording the completion frequency.

Information display system in FIG. 3 also has an intermediate credit fund account 330-1a. In the embodiment shown in FIG. 3, the intermediate credit fund account 330-1a is included in the recorder module 330-1. The intermediate credit fund account 330-1a is used for both facilitating payments of the electronic commercial transactions and recording the number of successful payments made in relation to the electronic commercial transactions. As discussed herein, the number of successful payments recorded provides a basis for calculating the CoP of each information objects. The intermediate credit fund account 330-1a may also be adapted for transferring funds to a receiving account (not shown) to complete each payment and for deducting the bidding price of the respective information object.

The intermediate credit fund account 330-1a shown in FIG. 3 is an integral part of the recorder module 330. However, the intermediate credit fund account 330-1a and the recorder module 330 may also be two separate units. In this case, the intermediate credit fund account 330-1a may send the information regarding the number of completed payments to the recorder module 330 to be recorded and further processed.

It is further appreciated that the intermediate credit fund account 330-1a may be replaced an external account which has established proper data communications with the other components of the information display system. The external account may even be an account held by a third party such as a payment service provider.

The search unit 340 is for receiving a search query from a user, and finding product information objects that satisfy the search query. The display position managing unit 310 ranks the matching information objects according to their CoP and confers the information display position to the information objects based on the ranking result.

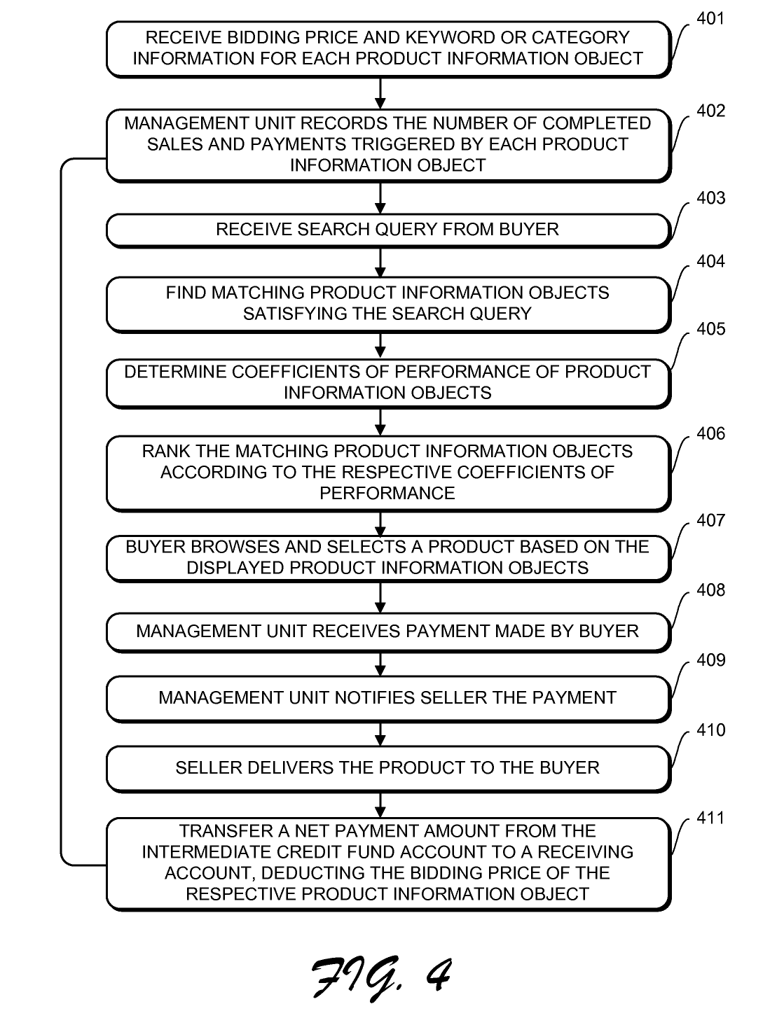

FIG. 4 shows a flow diagram of a price-bid ranking method in accordance with the present invention. The price-bid ranking method is for ranking a plurality of product information objects used in online commerce. The method can be viewed as a more specific application of the methods and the system described in FIGS. 1-3. The method applies to situations where the information objects are product information used in online commerce (such as marketing, retailing, trading, services and advertisements). In a typical situation, the resource users (the providers of information objects in the present embodiment) are sellers or advertisers; the third-party users are buyers; and the triggered actions are electronic commercial transactions such as purchases of a product.

Preferably, sellers or their representatives are required to register as members through some form of ID verification in order to guarantee the quality of the product information provided by the sellers and the authenticity of the seller's identification. The sellers may also be required to prove that they have in their possession the goods which they will offer for sale online. After satisfying the prerequisites to become a member, the seller may enter a process of price-bid ranking to sell the product.

An exemplary process of the price-bid ranking method is described in blocks in the following.

At block 401, the price-bid ranking system receives a bidding price for ranking each product information object. The price-bid ranking system may also receive keyword or category information for describing the characteristics of each product. In an exemplary process, a seller requests for bidding and sets a bidding price and keyword(s) for a product offered for sale. Each seller may have multiple products for sale. An information object may contain information for a single product but may also contain information for multiple products. An information object may contain a link that links to a single or a group of products, or even to a complete online storefront.

Bidding is used as a marketing method for helping the sellers to maximize the value of their products or goods offered for sale or trade. Typically, the bidding price is offered by a resource user, such as a seller, a trader, an advertiser or a representative thereof, trying to have the respective product information object listed in the ranking. The bidding may be open to all qualified resource users who wish to display a product on the price-bid ranking system. The price-bid ranking method follows certain rules to rank all participating products or goods.

For example, the result of the price-bid in ranking may be a webpage display which lists products offered by sellers. The products of the sellers who are ranked the highest may be listed at premium display positions such as special recommended positions, top 20 list on the first page, top 10 list on the subsequent pages, etc. Such premium display positions are desirable because according to the reading and browsing habits of people, items ranked at the top or otherwise ranked prominently tend to receive more views and trigger more actions. In fact, on website displays, products that are placed at prominent recommended positions nearly always receive the highest number of clicks.

The keyword is usually a distinctive character of the product, used as an easy and intuitive identifier, such as a brand name, in order to assist buyer's searching for the product. The bidding price is a fee the seller pays to the price-bid ranking system after the completion of a sale, in exchange for using the ranking service. For example, a seller who sells Nike brand footwear may set a keyword “Nike” and a bidding price of $1 for the ranking service.

The fee may be charged on various schemes, such as a fee per click, a fee per thousand clicks, a fee per sale, a fee per successful payment, or a fee for a certain length of time of using the ranking service, depending on the business model of the display ranking service provider.

At block 402, the management unit of the price-bid ranking system starts to record the number of completed sales and payments triggered by each product information object ranked and displayed. Sales and payments are made as the product information objects are ranked and displayed at various information display positions such as conspicuous recommended positions. The management unit records, for each product information, the number of times the product information has been displayed at buyer's end, the number of sales triggered, the number of successful payments made, and the sold price for each purchase. Such recorded information is used for determining the coefficient of performance (CoP) of each product information object ranked and displayed.

It is appreciated that the placement of block 402 in the sequence of the blocks shown in FIG. 4 may be only symbolic or at best illustrative. In practice, the recording may be a continuous process occurs in real time as sales and payments are conducted.

At block 403, the price-bid ranking system receives a search query from a buyer. The search query is generated when the buyer enters search words or search category information to search for product information relevant to the product the buyer wishes to purchase. For example, the buyer may enter a keyword “Nike” to search for products bearing the brand-name Nike.

The search is typically conducted at a data terminal such as a computer screen at the buyer's end, but carried out by a search unit such as a search engine of the price-bid ranking system. A typical user interface between the buyer and the search unit of the price-bid ranking system is a web browser.

In a common online shopping process, a buyer logs on the management unit of the price-bid ranking system. The logon may either be membership-based requiring a username and password or open to all shoppers who visit the price-bid ranking system, which typically has a webpage containing a search box, classified product categories, and listings of products. The buyer enters a relevant search word in the search box or selects a product category, or performs a combination of both, to search for a product to buy. The product categories are usually predetermined by the management unit according to the types of the products, such as apparel, electronics, computers, home and garden items, jewelry and sports goods. As the buyer clicks on the search button to submit the search query, the search unit of the management unit conducts a search and displays the search results, as described in the next step.

At block 404, upon receiving a search query of the buyer, the search unit of the management unit finds matching product information objects that contain the search word and/or belong to the search category indicated by the buyer. The search is based on matching the search query of the buyer with the keyword and/or category information entered by the seller regarding each product.

At block 405, the management unit determines the CoP of product information objects. In general, the CoP of each information object is a function of the bidding price and completion frequency of object transactions triggered by the product information object, and usually has a positive correlation with both. Here, object transactions refer to actions that are triggered by the display of a product information object. Generally, object transactions are commercial in nature. The most common example of an object transaction is a sale of a product.

The CoP provides a basis for ranking multiple information objects. The management unit ranks the participating product information objects according to certain rules preset by the price-bid ranking system. An example of such rules is to rank the participating product information objects according to the order of their CoP values, from high to low. That is, the product information objects with a higher CoP are ranked higher in competitive allocation of display positions. This arrangement tends to have a self-feeding effect of a positive cycle, as a higher CoP leads to a higher ranking, which leads to a better display position, which leads to a better viewership, which in turn is likely to lead to an even higher CoP.

The CoP can be formulated to represent the effectiveness of each product information objects, which is a measure of the benefit generated by each display of the respective product information object. Usually, such benefit is proportional to both the bidding price of the product information object and the completion frequency. However, if the bidding price is for per click regardless of the actual sales generated from the clicks, a more general trigger frequency defined by the frequency of clicks triggered by product information object displayed may be used instead of the completion frequency.

From a seller's point of view, it may be advantageous to pay a bidding price only for successful sales with actual payments made instead of for every click or every sale triggered including those that are abandoned or canceled. If such seller-preferred bidding price model is adopted, it is preferred to use the completion frequency defined as the number of successful transactions (sales or payments) triggered by the displayed product information object within a unit time.

The formula used for determining the CoP may vary according to the system design and the business needs. One simple formulation is to obtain the CoP by multiplying the bidding price by the completion frequency of successful transactions (e.g. sales, or payments). This simple formulation may be modified using modifying factors, which can be customized according to each seller, the characteristics of a product, or the characteristics of each product information object.

A CoP determined by bidding price and the completion frequency describes the effectiveness of the product information object in a unit time. Sometimes, two product information objects may show similar effectiveness per unit time but the first achieves that with fewer displays than the second. In this case, the first product information object is more efficient than the second in terms of the resource usage. In order to further evaluate the efficiency of a product information object, the CoP may also be formulated to have a negative correlation with the total number of times the product information object has been displayed during a predetermined period of time. In this formula, the main factors that affect the ranking of a product information object in the price-bid ranking are the bidding price, the trigger frequency (or completion frequency of successful transactions in some preferred embodiments), and the total number of displays.

For example, in order to further evaluate the efficiency, the CoP may be obtained by:

CoP=(bidding price×completion frequency)/total number of displays during a predetermined period of time.

Of course, more sophisticated formula may be used to determine the CoP for fine tuning the correlation between the CoP and the bidding price, completion frequency and the total number of displays.

It is appreciated that block 405 may take place at a different point of the process than that is shown in FIG. 4. For example, the CoP may be determined either on a periodical basis or in real time. The block 405 for determining the CoP may take place before the blocks 403 and 404. As shown in FIG. 4, the block 405 may also take place after the blocks 403 and 404 and immediately before the block 406.

At block 406, the management unit ranks the matching information objects according to their CoP, and allocates information display positions to the information objects according to their CoP ranking. Ranking according to the CoP tends to place products that are selling well ahead of other products. Products that are selling well usually have an advantage of both price and quality. The CoP-based ranking therefore more effectively promotes the best selling products to benefit both the seller and the buyer, while at the same time increases the financial benefits of the service provider of information displays.

At block 407, the buyer browses and selects a product based on the displayed product information objects, which may include an active Internet link to the checkout process where the purchase is completed with making a payment, but may also include a link to more product information and more product selections. If the buyer does not find the desired product in the displayed product information objects, the buyer may either end the process or start a new search.

At block 408, the system receives the payment made by the buyer. In one embodiment, an intermediate credit fund account is used for this purpose. The buyer may make the payment directly to the intermediate credit fund account. The buyer may even create a business account within the intermediate credit fund account to manage the outstanding balance of the purchase activities. Alternatively, the buyer may make the payment through an external account such as an independent payment service account which then transfers the fund to the intermediate credit fund account to complete the payment.

As has been described herein, the intermediate credit fund account may also be used for counting the number of successful payments made through the intermediate credit fund account. The number of successful payments is then used for estimate the completion frequency of sales triggered by the respective product information object.

At block 409, the management unit notifies the seller that the payment has been made.

At block 410, the seller delivers the product to the buyer. The seller may want to verify the payment before shipping the product to the buyer.

At block 411, after the seller has made the payment, the management unit transfers a net payment amount to the buyer. This step may be inapplicable if the payment has been made by the buyer without using, in any point of the transaction, the intermediate credit fund account of the price-bid system. Where the intermediate credit fund account of the price-bid system is used for making the payment, however, block 411 may be used for completing the payment. Even in case where the buyer initially makes the payment to an external account which subsequently transferred be fund to the intermediate credit fund account on behalf of the buyer, block 411 may be used for completing the payment.

To perform block 411, the intermediate credit fund account may transfer the net payment amount to a receiving account, which may either be an external account owned by the seller, or an internal account within the intermediate credit fund account held by the seller. In a typical arrangement, the net payment equals to the sold price of the product subtracted by the bidding price of the respective product information object. Alternatively, the total sold price of the product may be transferred first, while the bidding price is charged separately through the intermediate credit fund. In this alternative arrangement, the bidding price for multiple transactions may be charged in a lump sum instead of being individually charged each time after a sale is completed.

The management unit may choose to verify the delivery of the product to the buyer before executing block 411. If the seller has a business account within the intermediate credit fund account, the seller may also inquire the business account to verify the completion of the payment. The final closing up of the sale transaction, including invoicing, may either be conducted by the intermediate credit fund account in a centralized manner, or be handled between the seller and the buyer.

In case of a buyer's return of the product after the completion of the sale, the terms of the return and refund may be handled between the seller and the buyer. After a return and refund agreement has been established between the seller and buyer, however, the refund may be handled by the intermediate credit fund account. For example, the intermediate credit fund account may transfer the refund amount to an account held by the buyer, while the seller transfers or otherwise makes available the same amount to the intermediate credit fund account.

Furthermore, if there is an agreement for refunding the bidding price to the seller in the event of a product return, the refund for the bidding price may also be handled by the intermediate credit fund account.

The price-bid ranking method described in FIG. 4 enables an information display service provider to intelligently optimize the resource allocation. As disclosed above, in some embodiments the management unit promotes to the buyers those products that are not only best-selling products but also the most profitable for the service provider. If desirable, the system may charge the seller service fees only for a successful sale (i.e., no fee if no deal), thus benefiting both the seller and the buyer, and maximizing the service provider's profit at same time.

It is appreciated that the particular order of the blocks shown in FIG. 4 is only illustrative, and some blocks may be optional. Some blocks may be performed only periodically instead of in the every sale of a product. The CoP of the product information objects may be calculated in real time and provided instantly for ranking of the product information objects in each display of the product information, but may also be calculated periodically on a predetermined schedule to provide updated CoP information on a time-interval basis. Likewise, the block of ranking the product information objects may also be either performed in real time or periodically.

The above-described techniques may be implemented with the help of one or more computer-readable media containing computer-executable instructions. The computer computer-executable instructions enable a computer processor to perform an competitive resource allocation in accordance with the techniques described herein. It is appreciated that the computer readable media may be any of the suitable memory devices for storing computer data. Such memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-ex-complete instructions may either be delivered in a tangible physical memory device or transmitted electronically.

The invention has been described above using several exemplary embodiments and applications in FIGS. 1-4. Compared to be existing technology, the present invention potentially has the following benefits and advantages:

(1) The invention enables a management unit to acquire information regarding third-party actions or behaviors triggered by a resource user's use of a targeting information. The acquired information, such as trigger frequency of the third-party actions and related completion frequency of transactions, constituted a uniquely useful intelligence for optimizing the resource allocation. Invention introduces a concept of coefficient of performance (CoP) to take advantage of the acquired information and to more accurately measure the performance (effectiveness and efficiency) of a certain resource user or a corresponding data port. This results in a more accurate and effective resource allocation which optimizes resource usage and minimizes resource waste.

(2) The present invention introduces in some embodiments an intermediate credit fund account into the system to keep a record of the electronic transactions that are taking place in the system. The system is capable of recording third-party actions such as making a payment using the intermediate credit fund account. In the field of competitive information display in particular, for example, the system is able to take into account both the bidding price by the seller and successful sales triggered by the information displayed. This promotes those information display objects that are more effective in their use of the information display positions, and increases the effectiveness and the accuracy of the buyer's shopping experience (including searching, viewing and purchasing). Because the main purpose of displaying product information is to sell the product, the present invention directly enhances the core business of product information display. In addition, because the CoP may also be negatively correlated to the total display times of each product information object, the invention is also able to promote information display efficiency by awarding those products and information objects that generate a certain number of sales with the least number of displays. This feature may also enhance an overall search experience of buyers, as one of the common complaints by people searching for information on the Internet is the low relevance of the search results.

(3) The use of an intermediate credit fund account in some of the embodiments of the present invention makes possible a better integrated electronic transaction. For example, as a third-party user (e.g. a buyer) has confirmed the completion of an electronic transaction, the management unit can immediately transfer the corresponding payment fund to an account held by the resource user (e.g. a seller). This not only helps to accomplish instant and complete recording of the number of successful transactions, but also makes it possible to integrate the charging of the bidding prices with the making and receiving payments for the purchases. In some embodiments of the present invention, this integration enables the resource provider to reliably charge fees only after the resource user has actually received the benefit of using the resource, thus avoiding unnecessary cost of the resource users. In contrast, with the existing technologies, the resource provider is often willing to have a price model that is based on actual benefits of the resource user, but unable to implement such a price model due to the lack of proper information. The present invention thus enables an important business model based on the principle of “no fee if no deal”.

The above description, including the specification and drawings, is illustrative and not restrictive. Many variations of the invention will become apparent to those of skill in the art upon review of this disclosure. Various features and aspects of the above-described disclosure may be used individually or jointly. Further, the present disclosure can be utilized in any number of environments and applications beyond those described herein without departing from the broader spirit and scope of the specification. The scope of the invention should, therefore, be determined not with reference to the above description, but instead should be determined with reference to the appended claims along with their full scope of equivalents.

What is claimed is:

1. A method for interactive resource competition among a plurality of resource users competing for a target resource, the method comprising:
presetting a target resource;
receiving a reciprocal resource or an offer of a reciprocal resource from each resource user in exchange for using the target resource, wherein the reciprocal resource is quantifiable and can be represented by a reciprocal resource value;
recording a trigger frequency of a predetermined action triggered by each resource user using the target resource during a predetermined period of time;
determining a coefficient of performance of each resource user based on the respective reciprocal resource value and the trigger frequency; and
allocating the target resource based on the determined coefficients of performance.

2. The method as recited in claim 1, wherein the coefficient of performance has a positive correlation with the reciprocal resource value and the trigger frequency.

3. The method as recited in claim 1, wherein determining the coefficient of performance of each resource user comprises:
multiplying the reciprocal resource value by the trigger frequency of the respective resource user.

4. The method as recited in claim 1, wherein determining the coefficient of performance of each resource user comprises:
multiplying the reciprocal resource value by a resource modifying factor to obtain a modified reciprocal resource value;
multiplying the trigger frequency by a trigger frequency modifying factor to obtain a modified trigger frequency; and
multiplying the modified reciprocal resource value by the modified trigger frequency to obtain the coefficient of performance of the respective resource user.

5. The method as recited in claim 1 wherein allocating the target resource comprises:
conferring the target resource to the resource user having the greatest coefficient of performance.

6. The method as recited in claim 5, further comprising:
conferring the target resource to the resource user having the highest trigger frequency if the plurality of the resource users have the same coefficient of performance.

7. The method as recited in claim 1 wherein the target resource comprises at least one of the following:
data transmission bandwidth, data transmission priority, data transmission Quality of Service (QoS) and information display position.

8. The method as recited in claim 1 wherein the reciprocal resource of each resource user comprises an offer price.

9. The method as recited in claim 1 wherein the predetermined action triggered by each resource user comprises completion of an electronic commerce transaction.

10. The method as recited in claim 1 wherein the predetermined action triggered by each resource user comprises completion of an electronic commerce transaction, the method further comprising:
making payment of the electronic commerce transaction through an intermediate credit fund account.

11. The method as recited in claim 10, wherein recording the trigger frequency comprises:
counting a number of successful payments made through the intermediate credit fund account in relation to the electronic commerce transactions triggered by each resource user.

12. The method as recited in claim 10 wherein the reciprocal resource of each resource user comprises an offer price, the method further comprising:
charging the offer price through the intermediate credit fund account upon the completion of the triggered electronic commerce transaction.

13. A method for allocating an information display resource among a plurality of competing information objects each including product information used in electronic commerce, the method comprising:
presetting an information display position;
receiving a bidding price for displaying each information object at the information display position;
recording a completion frequency of electronic commerce transactions triggered by each information object during a predetermined period of time;
determining a coefficient of performance of each information object based on the respective bidding price and the completion frequency, wherein the coefficient of performance has a positive correlation with both the bidding price and the completion frequency; and
allocating the information display position based on the determined coefficients of performance.

14. The method as recited in claim 13, wherein determining the coefficient of performance of each information object comprises:
multiplying the bidding price by the completion frequency of the respective information object.

15. The method as recited in claim 13, wherein determining the coefficient of performance of each information object comprises:
multiplying the bidding price by a bidding price modifying factor to obtain a modified bidding price;
multiplying the completion frequency by a completion frequency modifying factor to obtain a modified completion frequency; and
multiplying the modified bidding price by the modified completion frequency to obtain the coefficient of performance of the respective information object.

16. The method as recited in claim 13 wherein allocating the information display position comprises:
conferring the information display position to the information object having the greatest coefficient of performance.

17. The method as recited in claim 13, further comprising:
conferring the information display position to the information object having the highest completion frequency if coefficients of performance of the plurality of the information objects are identical or too close to each other to be meaningfully ranked apart.

18. The method as recited in claim 13, further comprising:
making payments of the electronic commerce transactions through an intermediate credit fund account for each information object; and
counting the number of successful payments made through the intermediate credit fund account.

19. The method as recited in claim 13, further comprising:
setting a keyword; and
rejecting any of the plurality of information objects whose product information does not contain the keyword.

20. A price-bid ranking method for ranking a plurality of product information objects used in online marketing, the method comprising:
receiving a bidding price for ranking each product information object;
receiving a search query from an information user;
finding product information objects that satisfy the search query; and
ranking the matching product information objects according to coefficients of performance thereof, wherein the coefficient of performance of each information object is a function of the bidding price and completion frequency of object transactions triggered by the product information object.

21. The price-bid ranking method as recited in claim 20, further comprising:
allocating a plurality of information display positions to the matching product information objects according to a result of the ranking thereof.

22. The price-bid ranking method as recited in claim 20 wherein the object transaction comprises a sale of a product described in the respective product information object.

23. The price-bid ranking method as recited in claim 20, wherein the coefficient of performance of each product information object has a positive correlation with both the respective bidding price and the respective completion frequency of object transactions.

24. The price-bid ranking method as recited in claim 20, wherein the coefficient of performance of each product information object has a negative correlation with total number of times the product information object has been displayed during a predetermined period of time.

25. The method as recited in claim 20, further comprising:
receiving through an intermediate credit fund account payments for the object transactions triggered by each product information object; and
for each product information object, counting the number of successful payments made through the intermediate credit fund account, the number of successful payments being used for determining the completion frequency of object transactions triggered by the respective product information object.

26. The method as recited in claim 20, further comprising:
for each product information object, charging the bidding price through an intermediate credit fund account upon completion of each object transaction.

27. The method as recited in claim 25, wherein receiving payment for each object transaction comprises:
transferring a net payment amount from the intermediate credit fund account to a receiving account, wherein the net payment equals to sold price of the object transaction subtracted by the bidding price of the respective product information object.

28. The method as recited in claim 20, wherein the coefficients of performance of the plurality of product information objects are calculated in real time, and ranking the product information objects is performed in real time.

29. One or more computer-readable media storing computer-executable instructions that, when executed, perform acts comprising:
calculating coefficients of performance as a function of bidding prices offered by information objects for occupying predetermined information display positions and completion frequencies of electronic commercial transactions triggered by the information objects; and
ranking the information objects according to the coefficients of performance.

30. A system for competitive display of a plurality of information objects, where individual information objects include product information for electronic commerce, the system comprising:
a display position managing unit to predetermine an information display position and confer the information display position to an information object according to a coefficient of performance of the information object;
a computing unit to calculate the coefficient of performance as a function of a bidding price offered by each information object for occupying the predetermined information display position and a competition frequency of electronic commercial transactions triggered by the information object; and
a management unit including a receiver module and a recorder module, the receiver module being used to receive the bidding price and to record the completion frequency.

31. The system as recited in claim 30, wherein the display position managing unit ranks the plurality of information objects according to the coefficients of performance thereof and confers the information display position to the plurality of information objects based on a ranking result.

32. The system as recited in claim 30, further comprising:
a search unit to receive a search query from a user, and find product information objects that satisfy the search query, wherein the display position managing unit ranks the information objects according to the coefficients of performance and allocates the information display position to the information objects based on a ranking result.

33. The system as recited in claim 30, wherein the coefficient of performance has a positive correlation with both the bidding price and the competition frequency.

34. The system as recited in claim 30, wherein the management unit further includes an intermediate credit fund account for making payments in the electronic commercial transactions.

35. The system as recited in claim 34, wherein the recorder module receives information regarding the number of completed electronic commercial transactions from the intermediate credit fund account.

36. The system as recited in claim 34, wherein the intermediate credit fund account is adapted for transferring funds to a receiving account and for deducting the bidding price offered by the respective information object.
